(19) United States
(12) Patent Application Publication
(10) Pub. No.: US 2009/0168010 A1
(43) Pub. Date: Jul. 2, 2009

(54) Adaptive focusing using liquid crystal lens in electro-optical readers

(76) Inventors: Igor Vinogradov, New York, NY (US); Chinh Tan, Setauket, NY (US)

Correspondence Address: KIRSCHSTEIN, ISRAEL, SCHIFFMILLER & PIERONI, P.C., 425 Fifth Avenue, 5TH FLOOR, New York, NY, 10016-2223, US

(21) Appl. No.: 12/005,577

(22) Filed: Dec. 27, 2007

(51) Int. Cl. G02F 1/1333

(52) U.S. Cl. 349/200

(57) ABSTRACT

Working range and beam cross-section are adjusted in an electro-optical reader for reading indicia by applying voltages to electrodes in one or more liquid crystal lenses in which the index of refraction is changed.

### DESCRIPTION OF THE RELATED ART

Solid-state imaging systems or imaging readers, as well as moving laser beam readers or laser scanners, have both been used to electro-optically read one-dimensional bar code symbols, particularly of the Universal Product Code (UPC) type, each having a row of bars and spaces spaced apart along one direction, and two-dimensional symbols, such as Code 49, which introduced the concept of vertically stacking a plurality of rows of bar and space patterns in a single symbol. The structure of Code 49 is described in U.S. Pat. No. 4,794,239. Another two-dimensional code structure for increasing the amount of data that can be represented or stored on a given amount of surface area is known as PDF417 and is described in U.S. Pat. No. 5,304,786.

The imaging reader includes a solid-state imager or sensor having an array of cells or photosensors, which correspond to image elements or pixels in a field of view of the imager, and an imaging lens assembly for capturing return light scattered and/or reflected from the symbol being imaged. Such an imager may include a one- or two-dimensional charge coupled device (CCD) or a complementary metal oxide semiconductor (CMOS) device and associated circuits for producing electronic signals corresponding to a one- or two-dimensional array of pixel information over the field of view.

It is therefore known to use the imager for capturing a monochrome image of the symbol as, for example, disclosed in U.S. Pat. No. 5,703,349. It is also known to use the imager with multiple buried channels for capturing a full color image of the symbol as, for example, disclosed in U.S. Pat. No. 4,613,895. It is common to provide a two-dimensional CCD with a 640×480 resolution commonly found in VGA monitors, although other resolution sizes are possible.

Laser beam readers generally include a laser for emitting a laser beam, a focusing lens assembly for focusing the laser beam to form a beam spot having a certain size at a predetermined working distance, a scan component for repetitively scanning the beam spot across a target symbol in a scan pattern, for example, a line or a series of lines across the target symbol, a photodetector for detecting light reflected and/or scattered from the symbol and for converting the detected light into an analog electrical signal, and signal processing circuitry including a digitizer for digitizing the analog signal, and a microprocessor for decoding the digitized signal based upon a specific symbology used for the symbol.

It is desirable that the symbol be capable of being imaged or scanned over an extended range of working distances relative to the reader. It is conventional to move one or more lenses in the imaging lens assembly and, in turn, to move imaging planes at which the symbol is located and imaged between a near position close to the reader and a far position further away from the reader. It is also conventional to move one or more lenses in the focusing lens assembly and, in turn, to move the focus of the laser beam between the near and far positions. This lens movement is typically performed mechanically. This is disadvantageous for several reasons. First, the mechanical movement generates vibrations that are propagated through the reader to a user's hand in a handheld mode of operation, and may also generate dust to obscure the lens assembly. Moreover, the vibrations can generate objectionable, annoying, audible hum. In addition, the lens movement requires a drive that, in turn, consumes electrical power, is expensive and slow, can be unreliable, occupies space and increases the overall weight, size and complexity of the reader.

To avoid such mechanical movement, a variable focus liquid lens based on an electro-wetting effect has been proposed in U.S. Pat. No. 7,201,318 and No. 7,264,162 for use in both imaging and laser beam electro-optical readers, in which an electrical voltage is applied to the liquid lens to change an optical property, e.g., a focal length, thereof in accordance with a transfer function that resembles a parabola when a reciprocal of focal length is plotted against the applied voltage. The liquid lens, however, has an unpredictable, nonlinear, curved transfer function and, in practice, exhibits a hysteresis property, in which the transfer function for increasing applied voltages is different from the transfer function for decreasing applied voltages. Also, the transfer function is distorted by ambient temperature, in that the transfer function at colder temperatures is different from that at warmer temperatures.

It has further been proposed, for example, in U.S. Pat. No. 4,190,330, No. 5,305,731, and No. 6,859,333 to achieve variable focusing using liquid crystal (LC) materials and cells of the type used in optical displays. However, the known LC cells are not entirely uniform or homogeneous and undesirably scatter light, thereby producing a non-uniform optical response.

### SUMMARY OF THE INVENTION

One feature of this invention resides, briefly stated, in an arrangement for, and a method of, scanning a target, such as one- and/or two-dimensional bar code symbols, as well as non-symbols. The arrangement includes an optical assembly through which light passes along an optical path. The optical assembly includes a variable liquid crystal (LC) lens having a pair of light-transmissive, electrically conductive electrodes and a nematic LC layer between the electrodes. The LC layer has a changeable optical index of refraction. The arrangement further includes a controller for applying a voltage across the electrodes to change the index of refraction of the LC layer, and for optically modifying the light passing through the LC lens to have different optical characteristics.

In the case of a moving beam reader, a light source, such as a laser, is operative for emitting the light passing through the LC lens to the target for reflection therefrom. The different optical characteristics are different focal planes spaced apart along the optical path at different working distances relative to the LC lens. In the case of an imaging reader, a solid-state sensor or imager, such as a CCD or a CMOS array, is operative for receiving the light passing through the LC lens from the target. The different optical characteristics are different imaging planes spaced apart along the optical path at different working distances relative to the LC lens.

In a preferred embodiment, the controller is operative for continuously applying the voltage as a periodic voltage during scanning. An analyzer is advantageously provided for determining whether the target was a symbol that was successfully electro-optically read, and wherein the controller is operative for applying the voltage upon a determination that the symbol was not successfully electro-optically read.

In one embodiment, one of the electrodes of the LC lens is preferably curved and disposed in a substrate located at one side of the LC layer, and the other of the electrodes is preferably generally planar and deposited on another substrate located at an opposite side of the LC layer. The LC layer has a generally uniform dimension between the electrodes. Another embodiment includes a plurality of uniform LC layers between a plurality of generally planar electrodes for changing the index of refraction axially along the optical path. Still another embodiment resides in changing the index of refraction radially of the optical path.

The optical assembly preferably includes a fixed focal lens spaced along the optical path apart from, or integral with, the LC lens at one side thereof, or another fixed focal lens spaced along the optical path apart from, or integral with, the LC lens at an opposite side thereof. The LC lens may be the only component in the respective lens assembly, or the LC lens may have one or more lenses at either or both sides thereof. The optical assembly also preferably includes another LC lens having a changeable optical index of refraction along the optical path, in which case the controller is operative for changing each index of refraction, and for optically modifying the light passing through each LC lens to have different optical characteristics. In the case of the moving beam reader, the light passing through one of the LC lenses focuses the light beam at one of the working distances along the optical path, and the light passing through the other of the LC lenses has a selected cross-section at the one working distance.

The changing between different focal planes, different imaging planes, and/or the changing of the light cross-section is performed without mechanically or physically moving solid lenses, thereby decreasing the noise and vibration and dust in such readers, as well as the size, weight, power and volume requirements. The variable LC lens will not wear out over time.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic diagram of a handheld moving laser beam reader for reading a bar code symbol in accordance with the prior art;

FIG. 2 is a schematic diagram of a handheld imaging reader for imaging a target in accordance with the prior art;

FIG. 3 is a diagrammatic view of one embodiment of a variable LC lens for use in the reader of FIG. 1 or FIG. 2 in accordance with this invention;

FIG. 4 is a graph showing the index of refraction of the LC lens of FIG. 3 change for different applied voltages lengthwise across the LC lens;

FIG. 5 is a diagrammatic view of an arrangement using the LC lens in the reader of FIG. 1;

FIG. 6 is a diagrammatic view of an arrangement using the LC lens in the reader of FIG. 2; and

FIG. 7 is a diagrammatic view of an arrangement using two LC lenses in the reader of FIG. 1;

FIG. 8 is a diagrammatic view of another embodiment of a variable LC lens for use in the reader of FIG. 1 or FIG. 2 in accordance with this invention;

FIG. 9 is a diagrammatic view of yet another embodiment of a variable LC lens for use in the reader of FIG. 1 or FIG. 2 in accordance with this invention; and

FIG. 10 is a side view of the embodiment of FIG. 9.

### DETAILED DESCRIPTION OF THE PREFERRED EMBODIMENTS

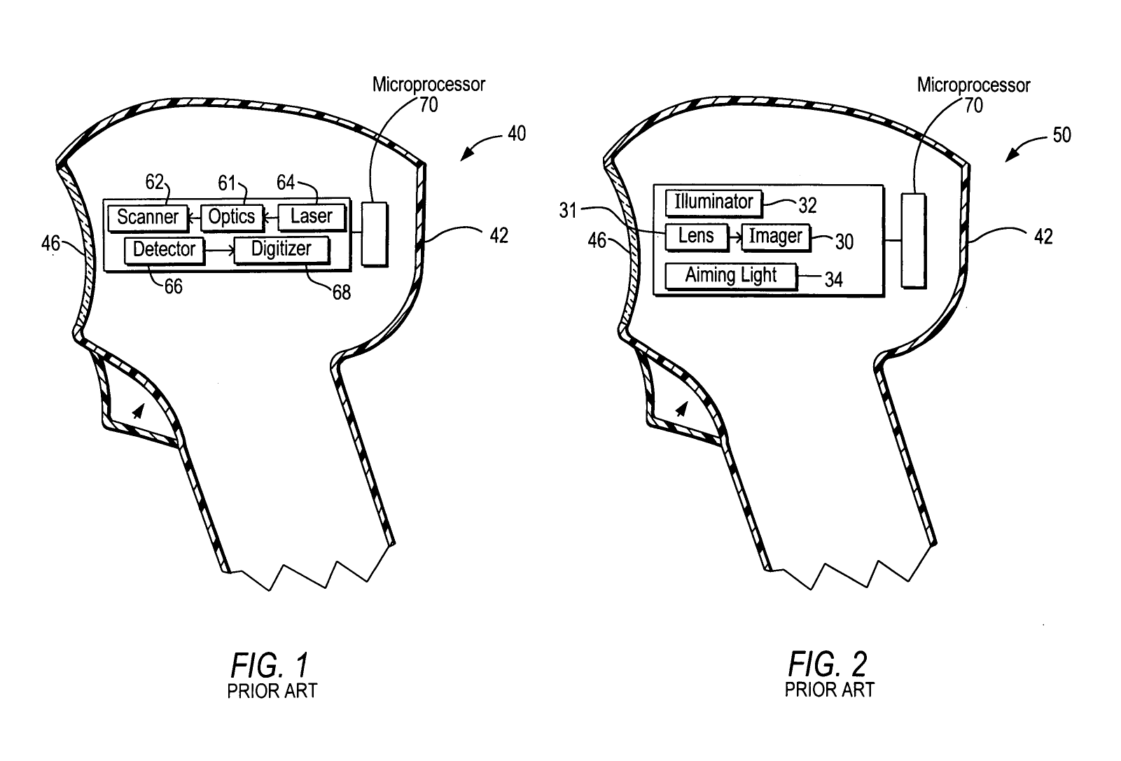

FIG. 1 depicts a conventional moving laser beam reader 40 for electro-optically reading indicia, such as a symbol, that may use, and benefit from, the present invention. The beam reader 40 includes a scanner 62 in a housing 42 for scanning an outgoing laser beam from a laser 64 and/or a field of view of a light detector or photodiode 66 in a scan pattern, typically comprised of one or more scan lines, through a window 46 across the symbol for reflection or scattering therefrom as return light detected by the photodiode 66 during reading. The beam reader 40 also includes a focusing lens assembly or optics 61 for optically modifying the outgoing laser beam to have a large depth of field, and a digitizer 68 for converting an electrical analog signal generated by the detector 66 from the return light into a digital signal for subsequent decoding by a microprocessor or controller 70 into data indicative of the symbol being read.

FIG. 2 depicts a conventional imaging reader 50 for imaging targets, such as indicia or symbols to be electro-optically read, as well as non-symbols, that may use, and benefit from, the present invention. The imaging reader 50 includes a one- or two-dimensional, solid-state imager 30, preferably a CCD or a CMOS array, mounted in the housing 42. The imager 30 has an array of image sensors operative, together with an imaging lens assembly 31, for capturing return light reflected and/or scattered from the target through the window 46 during the imaging to produce an electrical signal indicative of a captured image for subsequent decoding by the controller 70 into data indicative of the symbol being read, or into a picture of the target.

When the reader 50 is operated in low light or dark ambient environments, the imaging reader 50 includes an illuminator 32 for illuminating the target during the imaging with illumination light directed from an illumination light source through the window 46. Thus, the return light may be derived from the illumination light and/or ambient light. The illumination light source comprises one or more light emitting diodes (LEDs). An aiming light generator 34 may also be provided for projecting an aiming light pattern or mark on the target prior to imaging.

In operation of the imaging reader 50, the controller 70 sends a command signal to pulse the illuminator LEDs 32 for a short time period, say 500 microseconds or less, and energizes the imager 30 during an exposure time period of a frame to collect light from the target during said time period. A typical array needs about 33 milliseconds to read the entire target image and operates at a frame rate of about 30 frames per second. The array may have on the order of one million addressable image sensors.

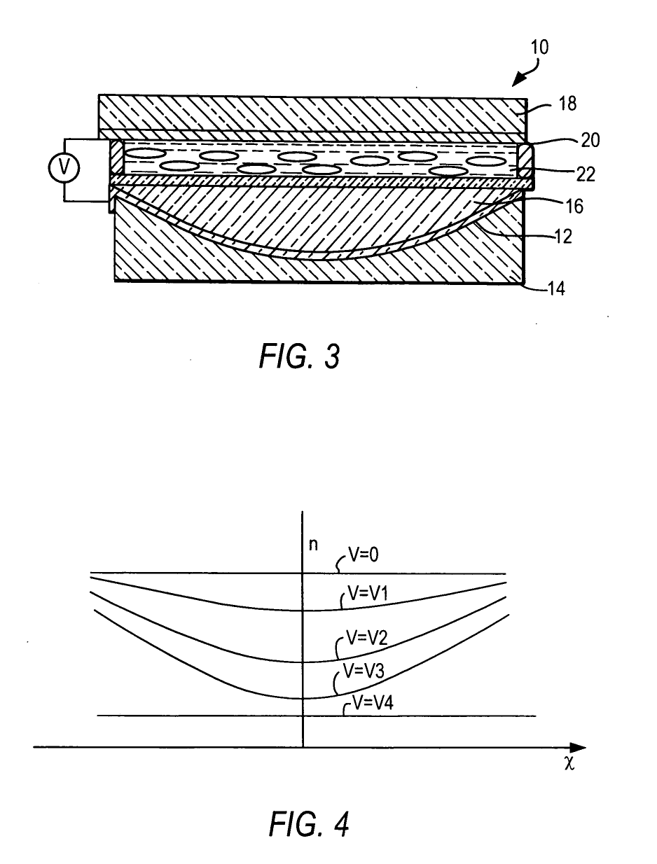

In accordance with this invention, the focusing lens assembly 61 or the imaging lens assembly 31 is configured with a variable liquid crystal (LC) lens 10, as shown in isolation in FIG. 3. In a first embodiment, the LC lens 10 has a first, glass or polymer, substrate having a lower portion 14 with a concave surface, an upper portion 16 with a convex surface of complementary contour to the concave surface, and a curved, optically transparent, electrically conductive, electrode 12 made from a material such as indium-tin-oxide between the upper and lower portions of the substrate. The LC lens 10 also has a second, glass or polymer, generally planar substrate 18 having a surface coated with a generally planar, optically transparent, electrically conductive, electrode 20. The two substrates 13 and 14 face an LC layer or cell 22, and are coated with alignment layers (not shown). Alignment layers are used on the opposing surfaces of the substrates adjacent to the LC layer to produce a homogeneous alignment. Persons skilled in the art may select from a wide variety of materials, usually polyimides, including, but not limited to, polyvinyl alcohol (PVA) for use as alignment layers on the substrates. The LC layer is injected into the cell.

The LC layer 22 has at least one semi-ordered, mesomorphic or nematic phase, in addition to a solid phase and an isotropic liquid phase. Molecules of the nematic LC layer typically are rod-shaped with the average direction of the long axes of the rod-shaped molecules being designated as the director, or may be disk-shaped with the direction perpendicular to the disk-shaped molecules being designated as the director. The nematic phase is characterized in that the directors are aligned in a preferred direction.

Birefringence in nematic LC materials is most readily described in terms of a splitting of incoming light entering the LC layer into two perpendicularly polarized rays called the ordinary ray and the extraordinary ray. A variation in a refractive index of the LC layer 22 with respect to the extraordinary ray is effected by varying the angle between the directors relative to the direction of the incoming light. Such tilting of the directors in the LC layer is produced by varying the strength of an electric or magnetic field across the LC layer 22. The directors typically tend to align themselves generally parallel to the direction of the electric or magnetic field. There is a threshold field strength below which the directors do not appreciably respond to the applied field and above which they respond monotonically as the field strength increases until realignment in response to the field reaches saturation.

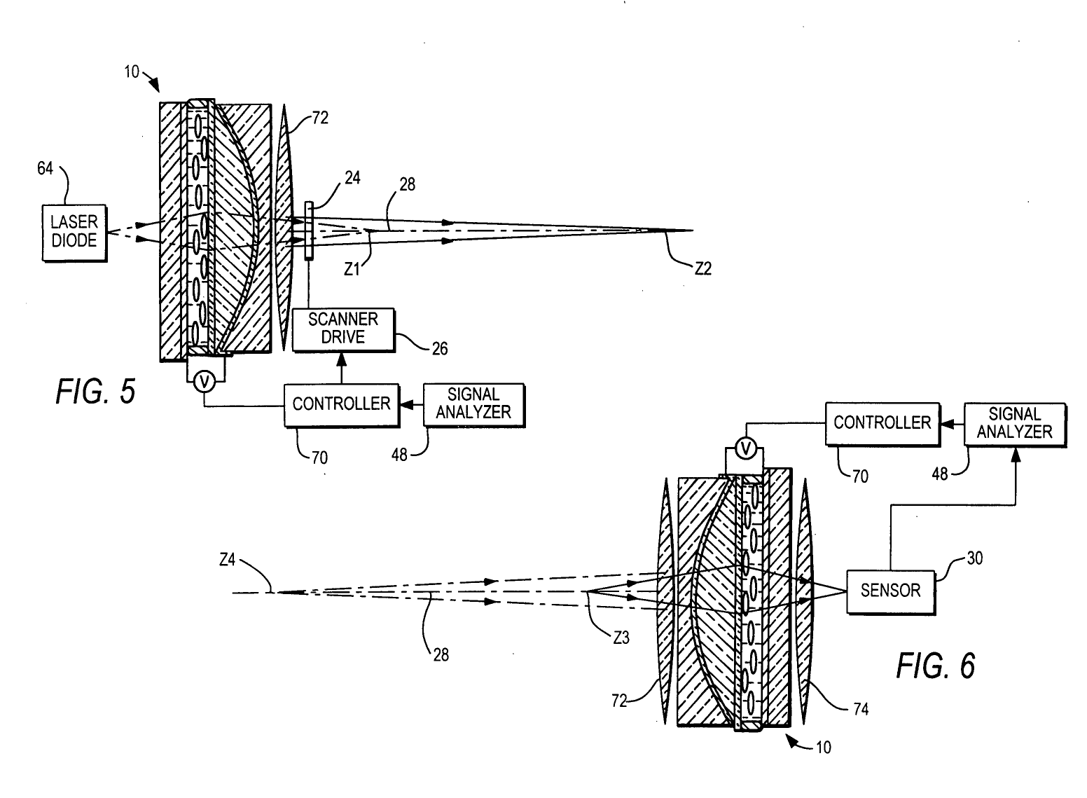

The refractive index of the LC layer 22 changes in response to a change of field strength to produce a variation of optical properties, e.g., focal length, in the focusing lens assembly 61 in the beam reader of FIG. 5, or the imaging lens assembly 31 in the imaging reader of FIG. 6. When a voltage V is applied across the electrodes 12, 20, the electric field will produce a centro-symmetrical gradient distribution of refractive index “n” within the LC layer 22, as shown in FIG. 4, in which voltage-dependent gradient refractive index profiles extending lengthwise in the direction “x” across the LC layer are shown.

The LC layer 22 causes light to be modified, e.g., focused, when a suitable voltage is applied across the electrodes. In FIG. 2, V1, V2, V3 and V4 are the applied voltages for adjusting the focal length of the focusing lens assembly. At V=0, the LC layer is uniform; thus, the focusing effect does not occur. As the applied voltage increases gradually, the non-uniform electric field causes different degrees of reorientation to the LC directors. As a result, a gradient refractive index profile is formed. The incident light is therefore focused. If the applied voltage V4 is much higher than a threshold voltage of the LC layer, then all the LC directors will be aligned generally perpendicular to the substrates. Under such a condition, the gradient refractive index is flat and the focusing effect is non-existent.

Turning to FIG. 5, the light source 64 of FIG. 1 is shown as a laser diode. The scanner 62 includes an oscillatable scan mirror 24 and its drive 26, both of which are separately depicted in FIG. 5. The change in voltage in the LC lens 10 is responsible for varying the focal point between a close-in position Z1 and a far-out position Z2 arranged along an optical path 28. The symbol can be read at, and anywhere between, these end-limiting positions, thereby improving the working range of the moving beam reader.

The voltage is preferably periodic, preferably a square wave drive voltage. The square wave is easily created with a variable duty cycle by the controller 70 having a built-in pulse width modulator circuit. The drive voltage could also be a sinusoidal or a triangular wave signal, in which case, the amplitude of the voltage controls the focal length and the working distance. The square wave does not require a voltage as high as the sinusoidal wave for a given change in focal length. When a square wave is used, focal length changes are achieved by varying the duty cycle. When a sinusoidal wave is used, focal length changes are obtained by varying the drive voltage amplitude. The amplitude or the duty cycle can be changed in discrete steps (digital manner) or continuously (analog manner) by the microprocessor or controller 70. The voltage could also be a constant DC voltage.

In the arrangement of FIG. 5, during reading, the laser beam is being scanned by the scan mirror 24 across focal planes generally transversely of the optical path or axis 28. The controller 70 may operate to apply the periodic voltage to the LC lens 10 at all times, or at selected times. Thus, the voltage can be applied for each scan, or for every other scan, etc. The voltage can be applied not only during scanning, but even afterward. The voltage can be initiated at the pull of a trigger, or only after a symbol has been detected. The voltage can be applied automatically, or only after a signal analyzer 48, preferably another microprocessor, has determined that the symbol being scanned has not yet been successfully decoded and read.

FIG. 6 is analogous to FIG. 5, except that it depicts an imaging reader having the imager 30, preferably a CCD or CMOS array with mutually orthogonal rows and columns of photocells, for imaging the symbol or target located at, or anywhere between, the imaging planes Z3 and Z4 arranged along the optical path 28, thereby providing the imager with an extended working range or depth of focus in which to collect light from the symbol. As before, the change in voltage when a periodic voltage is applied to the LC lens 10 enables the extended depth of focus to be achieved.

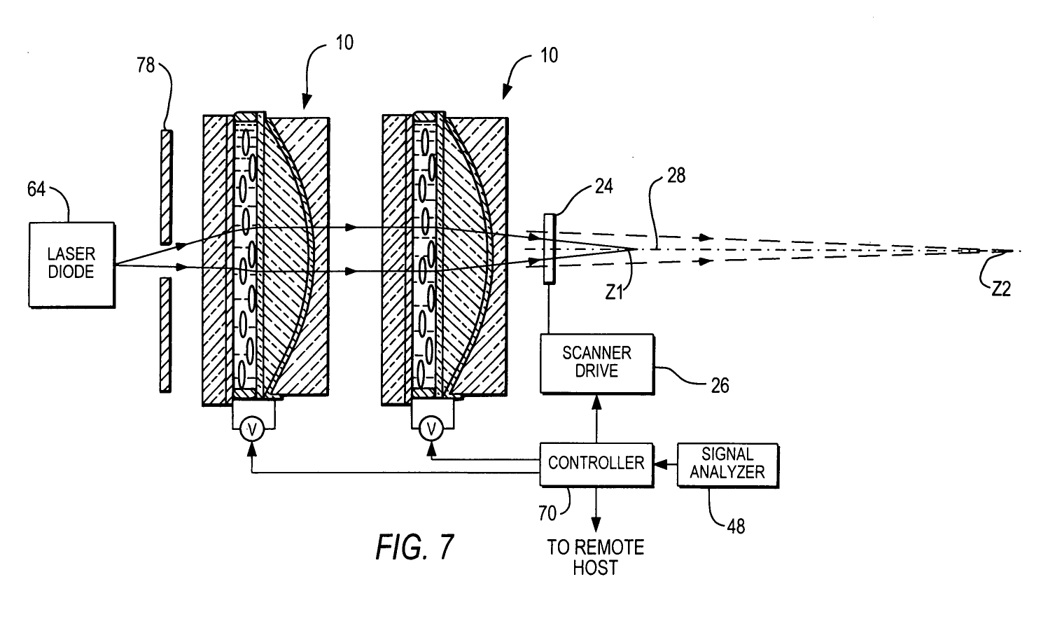

Each lens assembly 31, 61 may also have a fixed convex lens 72 (see FIGS. 5 or 6) at one axial end region of the LC lens 10, and/or another fixed lens 74 (see FIG. 6) at the opposite axial end region of the LC lens 10. Each fixed lens 72, 74 may be separate from, or integral with, the LC lens 10. Reference numerals 72, 74 may represent a single lens as shown, or a plurality of lenses, especially a triplet. Thus, the LC lens 10 may be the only component in the respective lens assembly, or the LC lens may have one or more lenses at either or both sides thereof. These fixed lenses 72, 74 assist in minimizing any kind of aberrations, for example, chromatic aberrations. Each lens assembly 31, 61 may advantageously include an aperture stop 78 (see FIG. 7) which can be positioned anywhere in the optical path 28.

For one-dimensional symbols, a more elliptical or elongated beam cross-section is desired. For two-dimensional symbols, a more circular beam cross-section is desired. By applying a periodic voltage, the LC lens 10 can optically modify the cross-section of the beam to different cross-sections. These shape changes can occur continuously or in stepwise manner and are especially useful in reading damaged or poorly printed symbols, thereby improving reader performance.

It will be seen that the change in focus and/or the change in beam cross-section is accomplished without mechanical motion of any solid lenses.

As shown in FIG. 7, more than one LC lens 10 can be arranged in series along the optical path 28. One LC lens can be used for focus variation, another can be used to change the beam cross-section and/or the magnification (i.e., the zoom effect). Multiple lenses can also be used to reduce astigmatism. One or both fixed lenses 72, 74 can be disposed at opposite sides of each LC lens.

The aperture stop 78 is advantageously positioned between the laser diode 64 and the first LC lens. The controller 70 has two outputs, one for each LC lens. Otherwise, the same reference numerals as were used above in connection with FIG. 5 have been used to identify like parts. The aperture stop 78 is operative to maintain a constant beam diameter for the dual lens system of FIG. 7, or the single lens systems of FIGS. 5 or 6.

As described above in connection with FIG. 5, varying the focal length will cause the beam spot or waist, i.e., the point where the laser beam has a minimum diameter in cross-section, to be moved between the different working range positions Z1 and Z2. When the focal length is varied, the size of the waist will change also. As the focal length is adjusted to move the waist outwards toward Z2, the waist increases in diameter, and when the waist is moved inwards toward Z1, the waist shrinks in diameter. As a result, resolution decreases as the waist is moved outwards, thereby resulting in a limitation in the capability of the reader to read high density symbols at far-out distances. On the other hand, it is sometimes desirable to scan with a large-sized waist at close-in distances, especially for reading damaged or low contrast symbols, because the large waist reduces speckle noise and reduces resolution making it easier for the reader to ignore printing defects.

The dual lens system of FIG. 7 enables the first LC lens to change the diameter of the waist where it is incident on the second LC lens. By controlling the waist diameter on the second LC lens, it is possible to maintain a constant waist size as the waist location is changed. The constant waist size can be large if desired for reading low density, damaged or low contrast symbols, or can be small for reading high density symbols over an extended range. The dual lens system can position any beam waist size at any working range distance as may be necessary for any scanning application. In a variant construction, one of the LC lenses can be replaced by a variable liquid lens, or by a lens movable by a motor.

The focal lengths of the two LC lenses can be controlled by the signal analyzer or microprocessor 48, either independently or simultaneously, in a coordinated manner to produce the desired waist size at the desired working distance. The waist size and/or working distance can be pre-set to optimize the reader for specific applications, or can be controlled by the microprocessor 48 running algorithms that analyze the return signal from the symbol and make adjustments as necessary to optimize the capability of the reader to read the symbol being scanned. Advantageously, the same microprocessor 70 used to decode the symbol is used as the signal analyzer 48. Moreover, the same microprocessor can be used to communicate the decoded data to a remote host computer via a hard-wired or wireless link, e.g., radio frequency or infrared.

In a moving beam scanner, not only can the LC lens be employed in the outgoing path toward the indicia to be read, but also the LC lens may be employed in the return path along which the reflected light returns to the photodetector 66. The LC lens may be positioned in front of the photodetector 66 to control optical automatic gain by changing the amount of the reflected light impinging on the photodetector 66. The dual LC lens system can also be used in an imaging reader in an analogous manner to that shown in FIG. 6.

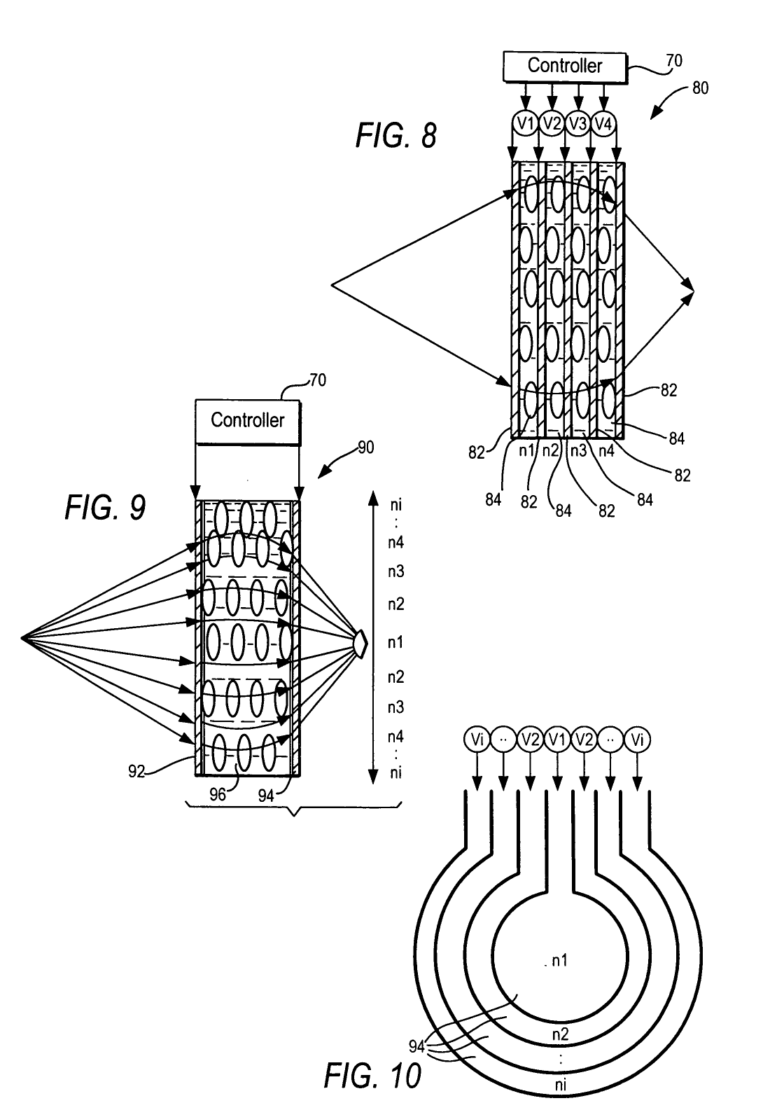

In another embodiment, as shown in FIG. 8, an LC lens 80 includes a plurality of transparent electrodes 82, each adjacent pair of electrodes bounding a plurality of LC layers 84. As described above, the controller 70 applies voltages V1, V2, V3, and V4 across each pair of electrodes. The amplitudes of the applied voltages are different to cause the indicies of refraction (n1, n2, n3, and n4) to change axially along the optical path. More or less than the four indicated LC layers can be used.

In still another embodiment, as shown in FIG. 9, an LC lens 90 includes an electrically grounded transparent electrode 92, and a plurality of part-circular electrodes 94 of different radii, as shown in FIG. 10, the electrodes bounding an LC layer 96 having a plurality of regions. As described above, the controller 70 applies voltages V1, V2, . . . Vi across the indicated electrodes. The amplitudes of the applied voltages are different to cause the indicies of refraction (n1, n2, . . . ni) to change radially of the optical path. More or less than the four indicated regions of the LC layer can be used.

It will be understood that each of the elements described above, or two or more together, also may find a useful application in other types of constructions differing from the types described above. For example, the embodiments of FIGS. 8 and 9 can replace either one or both of the embodiments of the LC lens employed in FIG. 7.

While the invention has been illustrated and described as embodied in adaptive focusing using one or more liquid crystal lenses in electro-optical readers, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. An arrangement for scanning a target, comprising:
an optical assembly through which light passes along an optical path, the optical assembly including a variable liquid crystal (LC) lens having a pair of light-transmissive, electrically conductive electrodes and a nematic LC layer between the electrodes, the LC layer having a changeable optical index of refraction; and
a controller for applying a voltage across the electrodes to change the index of refraction of the LC layer, and for optically modifying the light passing through the LC lens to have different optical characteristics.

2. The arrangement of claim 1; and a light source for emitting the light passing through the LC lens to the target for reflection therefrom; and wherein the different optical characteristics are different focal planes spaced apart along the optical path at different working distances relative to the LC lens.

3. The arrangement of claim 1; and a solid-state sensor for receiving the light passing through the LC lens from the target; and wherein the different optical characteristics are different imaging planes spaced apart along the optical path at different working distances relative to the LC lens.

4. The arrangement of claim 1, and wherein the controller is operative for continuously applying the voltage as a periodic voltage during scanning.

5. The arrangement of claim 1; and an analyzer for determining whether the target was a symbol that was successfully electro-optically read, and wherein the controller is operative for applying the voltage upon a determination that the symbol was not successfully electro-optically read.

6. The arrangement of claim 1, wherein one of the electrodes is curved and disposed in a substrate located at one side of the LC layer, wherein the other of the electrodes is generally planar and deposited on another substrate located at an opposite side of the LC layer, and wherein the LC layer has a generally uniform dimension between the electrodes.

7. The arrangement of claim 1, wherein the optical assembly includes a fixed focal lens spaced apart from the LC lens along the optical path.

8. The arrangement of claim 1, wherein the optical assembly includes two fixed focal lenses located at opposite sides of the LC lens along the optical path.

9. The arrangement of claim 1, wherein the optical assembly includes another LC lens having a changeable optical index of refraction along the optical path, and wherein the controller is operative for changing each index of refraction, and for optically modifying the light passing through each LC lens to have different optical characteristics.

10. The arrangement of claim 1, wherein the LC lens has additional LC layers, and wherein the controller changes each index of refraction of the LC layers axially along the optical path.

11. The arrangement of claim 1, wherein the LC lens has a plurality of regions of the LC layer, and wherein the controller changes the index of refraction of each region of the LC layer radially of the optical path.

12. An arrangement for scanning a target, comprising:
optical means through which light passes along an optical path through a variable liquid crystal (LC) lens having a changeable optical index of refraction; and
means for changing the index of refraction, and for optically modifying the light passing through the LC lens to have different optical characteristics.

13. A method of scanning a target, comprising the steps of:
passing light along an optical path through a variable liquid crystal (LC) lens having a changeable optical index of refraction; and
changing the index of refraction, and optically modifying the light passing through the LC lens to have different optical characteristics.

14. The method of claim 13, and configuring the LC lens with a pair of light-transmissive, electrically conductive electrodes and a nematic LC layer between the electrodes, the LC layer having the changeable index of refraction; and wherein the changing step is performed by applying a voltage across the electrodes to change the index of refraction of the LC layer.

15. The method of claim 13; and emitting the light passing through the LC lens to the target for reflection therefrom; and wherein the different optical characteristics are different focal planes spaced apart along the optical path at different working distances relative to the LC lens.

16. The method of claim 13; and receiving the light passing through the LC lens from the target; and wherein the different optical characteristics are different imaging planes spaced apart along the optical path at different working distances relative to the LC lens.

17. The method of claim 14, and wherein the changing step is performed by continuously applying the voltage as a periodic voltage during scanning.

18. The method of claim 14; and determining whether the target was a symbol that was successfully electro-optically read, and wherein the changing step is performed by applying the voltage upon a determination that the symbol was not successfully electro-optically read.

19. The method of claim 14, and configuring one of the electrodes to be curved and disposing the one electrode in a substrate located at one side of the LC layer, and configuring the other of the electrodes to be generally planar and deposit the other electrode on another substrate located at an opposite side of the LC layer, and configuring the LC layer with a generally uniform dimension between the electrodes.

20. The method of claim 13, and spacing a fixed focal lens apart from the LC lens along the optical path.

21. The method of claim 13, and locating two fixed focal lenses at opposite sides of the LC lens along the optical path.

22. The method of claim 13, and locating another LC lens having a changeable optical index of refraction along the optical path, and wherein the changing step is performed by changing each index of refraction, and by optically modifying the light passing through each LC lens to have different optical characteristics.

23. The method of claim 13, and configuring the LC lens with additional LC layers, and wherein the changing step is performed by changing each index of refraction of the LC layers axially along the optical path.

24. The method of claim 13, and configuring the LC lens with a plurality of regions of the LC layer, and wherein the changing step is performed by changing the index of refraction of each region of the LC layer radially of the optical path.
